(19) United States
(12) Patent Application Publication
(10) Pub. No.: US 2023/0169597 A1
(43) Pub. Date: Jun. 1, 2023

(54) SYSTEMS AND METHODS FOR BUILDING AND EXECUTING INSURANCE CONTRACTS

(71) Applicant: CoverGo Limited, Hong Kong (CN)

(72) Inventor: Alex Montgomery, Hong Kong (CN)

(73) Assignee: CoverGo Limited, Hong Kong (CN)

(21) Appl. No.: 17/853,465

(22) Filed: Jun. 29, 2022

Related U.S. Application Data
(60) Provisional application No. 63/283,528, filed on Nov. 28, 2021.

(51) Int. Cl. G06Q 40/08; G06F 3/04847; G06F 3/0486

(52) U.S. Cl. CPC G06Q 40/08; G06F 3/04847; G06F 3/0486

(57) ABSTRACT

A computerized system having a graphical user interface (GUI) to enable configurations of desirable insurance products via manipulations of interactive elements. In one aspect, the insurance clauses in a given insurance contract may be parameterized and reorganized to build units of coverage that may be evaluated against existing policies or risk data to determine the price and variability of the unit. The configured product may be evaluated in response to human input or other events to compute pricing, underwriting eligibility or adjudication of a claim against coverage in the policy. These units further expose data of the insurance clauses as visual blocks via the GUI while not requiring the users to code these clauses. In addition, embodiments provide a visual intuitive method for displaying insurance clauses relating to and facilitating configuration of an insurance product with digital, rules based, real-time computation of insurability, price and claims adjudication.

### CROSS-REFERENCE TO RELATED APPLICATION

This is a nonprovisional application claiming priority to a provisional application, Ser. No. 63/283,528, filed on Nov. 28, 2021, whose content is incorporated by reference in its entirety.

### FIELD OF INVENTION

This invention generally relates to insurance product generations. Particularly, aspects of the invention relate to dynamically generating and validating insurance products and contracts while creating application programming interfaces (APIs) to interact with legacy insurance systems.

### BACKGROUND

Financial contracts such as insurance contracts rely on the wording of conditions and clauses to define the rights and responsibilities of issuers and policy holders. Automating the execution of such contracts requires understanding of the contract domain and programming and automation techniques. As a direct consequence, creating new insurance products takes about 6-9 months and costs about 400 k-900 k USD (accordingly to PwC research). Current digital insurance product creation tools either require hiring an in-house product development team having the necessary computer programming skills. While this team enables the insurance issuers with faster development or product deployment, such approach lacks the flexibility to enable those not skilled in computer programming to create flexible insurance products that can be offered digitally. Therefore, current insurance product creation/management tools are either created just for internal use where additional editing, updating, trouble-shooting, etc., require users with in-depth computer software programming skills and knowledge. However, such tools are not aimed at non-programmers who lack the ability to create the type of sophisticated and complex insurance products with nested rules and pricing or dynamically respond to insurance claims user experience.

### SUMMARY

Aspects of the invention overcome the shortcomings of prior technologies by enabling insurance issuers, who are not skilled in computer programming, to intuitively configure digitized insurance products. In one embodiment, embodiments of the invention may include a visual intuitive display system for displaying and configuring insurance products. In another embodiment, aspects of the invention may include at least an insurance product administration portal and an insurance product user portal. In one example, the insurance product administration portal may display insurance clauses in a tree structure facilitating configuration of an insurance product with digital, rules based, real-time computation of insurability, price and claims adjudication.

Aspects of the invention further provide graphical user interface (GUI) to allow interactions with the user to configure the desirable insurance products. In one aspect, the insurance clauses in a given insurance contract may be parameterized and reorganized to build units of coverage that may be evaluated against existing policies or risk data to determine the price and variability of the unit. The configured product may be evaluated in response to human input or other events to compute pricing, underwriting eligibility or adjudication of a claim against coverage in the policy. In a further aspect, these units further expose data of the insurance clauses as visual blocks via the GUI while not requiring the users to code these clauses. In addition, embodiments of the invention provide a visual intuitive method for displaying insurance clauses relating to and facilitating configuration of an insurance product with digital, rules based, real-time computation of insurability, price and claims adjudication.

### BRIEF DESCRIPTION OF THE DRAWINGS

The invention may be better understood by references to the detailed description when considered in connection with the accompanying drawings. The components in the figures may not necessarily be to scale, emphasis instead being placed upon illustrating the principles of the invention. In the figures, like reference numerals designate corresponding parts throughout the different views.

FIGS. 1-4 illustrate exemplary embodiments of a graphical user interface (GUI) system according to some embodiments;

FIG. 5 illustrates an exemplary flow diagram of aspects of the invention according to some embodiments;

FIG. 6 illustrates another exemplary flow diagram of aspects of the invention according to some embodiments;

FIG. 7 is an illustration of a portable computing device suitable for aspects of the invention; and

FIG. 8 is an illustration of a server computing device suitable for aspects of the invention.

FIGS. 9-25 are exemplary screenshots of aspects of the invention.

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

Aspects of the invention may dramatically reduce the cost, complexity, and time to market for new insurance products. In some cases, embodiments of the invention enable entirely new types of fully-supported or tailored insurance platform with real-time pricing, underwriting and claims processing features. Embodiments of the invention may be sold directly to insurance companies, managed general agents (MGAs), reinsurers and other entities offering insurance products. In another embodiment, systems and methods of the invention may also be bundled with an insurance policy sales and administration system to manage insurance products and policies end-to-end.

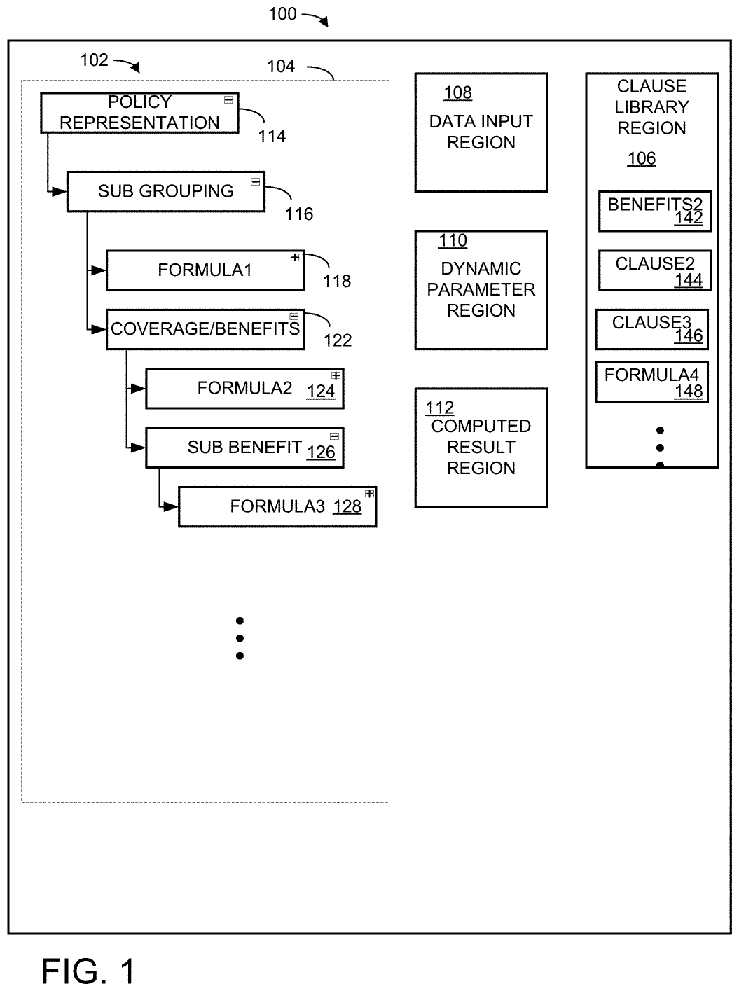

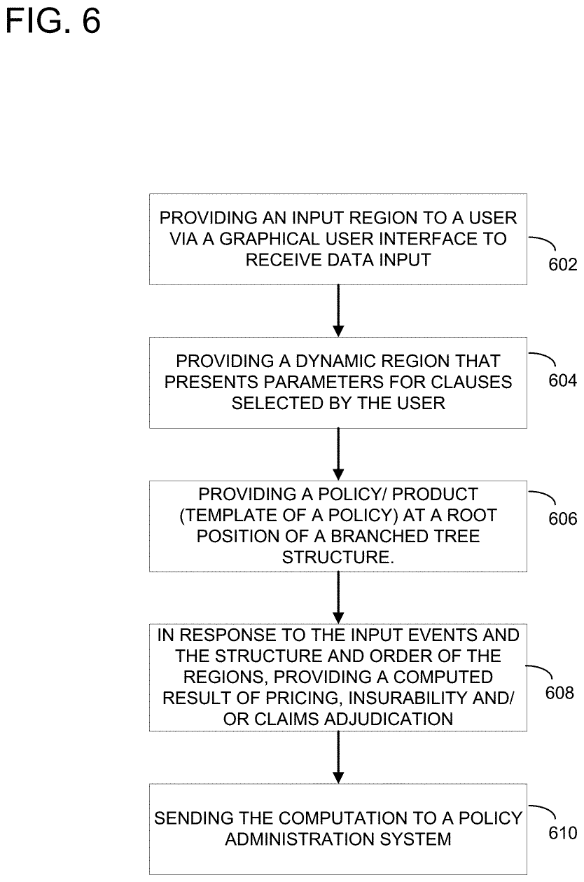

Referring to FIG. 1, an exemplary embodiment of a graphical user interface (GUI) system 100 according to one embodiment is illustrated. In one embodiment, the GUI system 100 may be included as a frontend system in a distributed computer system, as shown in FIG. 6. For example, the GUI system 100 may be displayed on a display, a monitor, or the like (not shown). In one embodiment, the GUI system 100 may be displayed in a virtual reality or augmented reality setting. In yet another embodiment, the GUI system 100 may be interact with a user. For example, the user may use input device, such as a mouse, a stylus, or other input devices to interact with the GUI system 100. In a further embodiment, the user may also use gestures to interact with the GUI system 100.

For example, the GUI system 100 may include one or more interactive elements or nodes 102 (to be generally referred to as “elements” hereafter). These interactive elements 102 may be organized in different regions, such as a product construction region 104, a clause library region 106, a data input region 108, a dynamic parameter region 110, a computed result region 112. Each of these interactive elements 102 expose a rich set of data for building an insurance product. In one aspect, the building of the insurance product may begin with the user selecting one of the interactive elements 102 in the clause library region 106. In one example, the interactive elements 102 in the clause library region 106 may represent one or more insurance clauses that an insurance product may include. For example, for a medical insurance policy, clauses such as whether the insured is a smoker may be a condition that may affect different benefits. Therefore, one of the interactive elements 120 in the clause library region 106 may be directed to such “smoker clause”.

In another embodiment, a processor, such as the processor 1000 may execute computer-executable instructions for configure aspects of the GUI system 100. For example, as shown in FIG. 1, each of the regions 103, 106, 108, 110, and 112 may include a display boundary (as shown by dashed boundary for the region 104, solid boundaries for the regions 106, 108, 110 and 112). The boundaries for these regions 104, 106, 108, 110, and 112 provide a visual construct for the user to enable different actions to be performed. For example, the clause library region 106 may enable the user to select each of the interactive elements 102 within the boundary of the region 106 and view the underlying data of each of the interactive elements 102 within the boundary of the region 106. Aspects of the invention enable the processor to technically configure the display region of the 106 to trigger actions for the user to interact with the interactive elements 102.

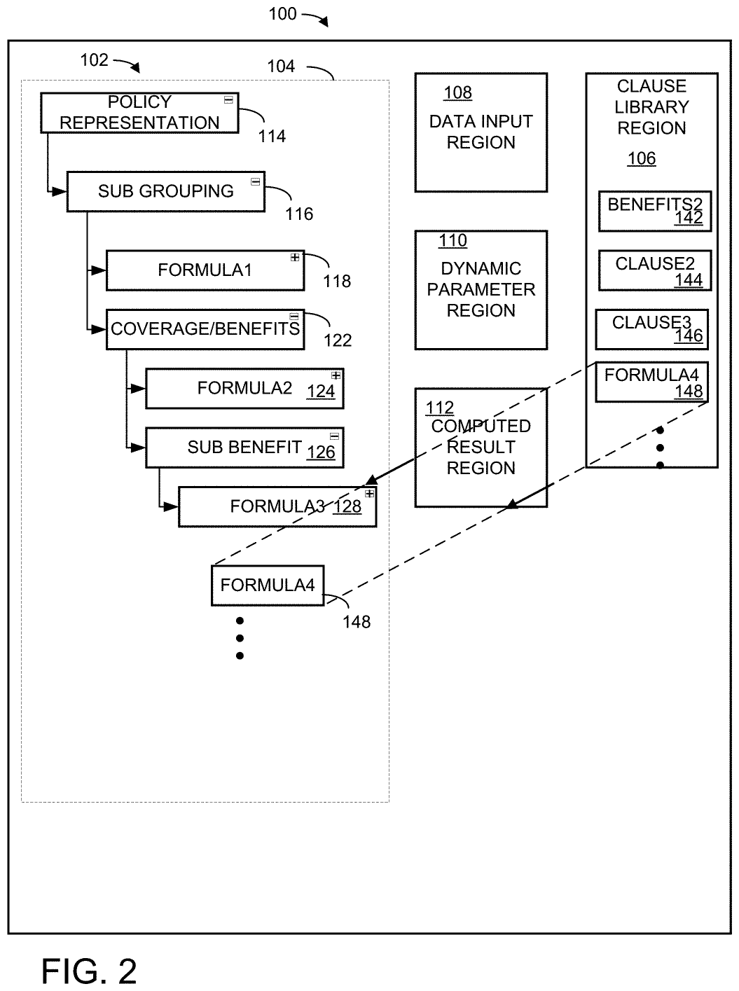

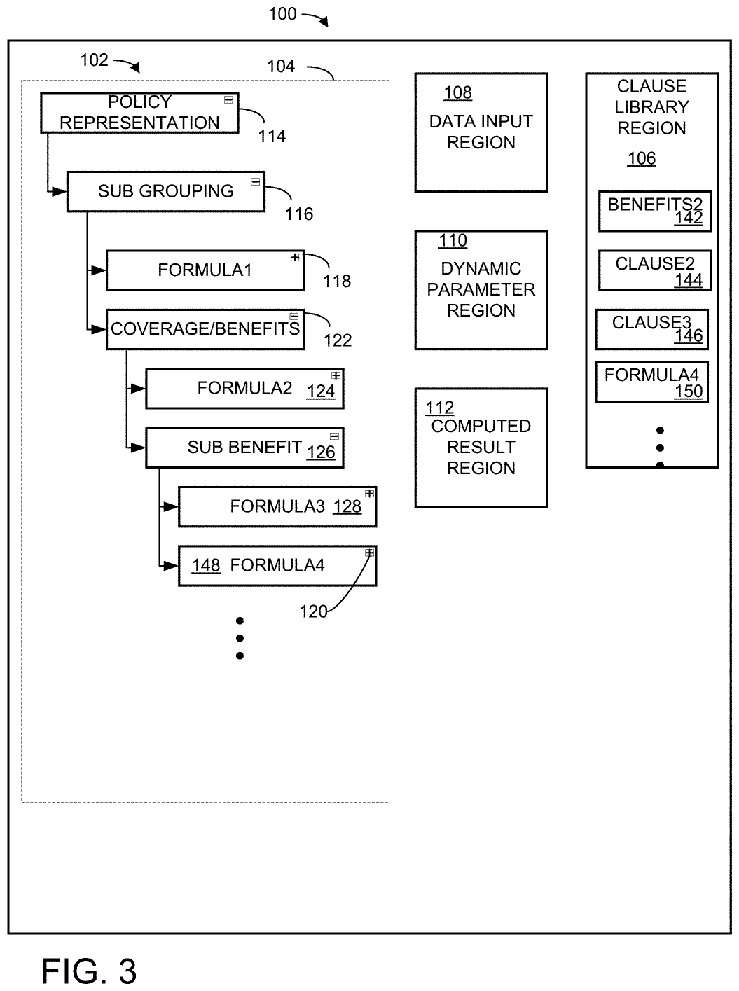

In the examples as shown in FIG. 2, the GUI system 100 may enable the user to select and then drag one or more of the interactive elements 102 from the region 106 and drop to the region 104. Upon dropping to the region 104, the processor 1000 may recognize the data, conditions, parameters and any information related to the dropped interactive elements 102. In response to the recognition, referring now to FIG. 3, the processor 1000 may then apply any data construct that is already in place to apply to the dropped interactive element 102. For example, the region 104 may currently organize the one or more interactive elements 102 in a tree structure as shown for building an insurance product. As discussed above, the one or more interactive elements 102 may include various insurance clauses or policy terms. As such, the processor 1000 may link and build the insurance product dynamically as the one or more interactive elements 102 are dropped to the region 104. In addition, the processor 1000 may provide notifications or warning if there are any exceptions or inconsistencies during the organization of the one or more interactive elements 102 for the insurance product. In another embodiment, if any of the interactive elements 102 include subparts or sub elements or data elements, then the processor 1000 may also recognize the sub parts or elements. In such an embodiment, the sub parts may be indicated by a plus sign 120. In another embodiment, the plus sign 120 may change to a “minus” sign once the parts are collapsed, exposed, or revealed to the user.

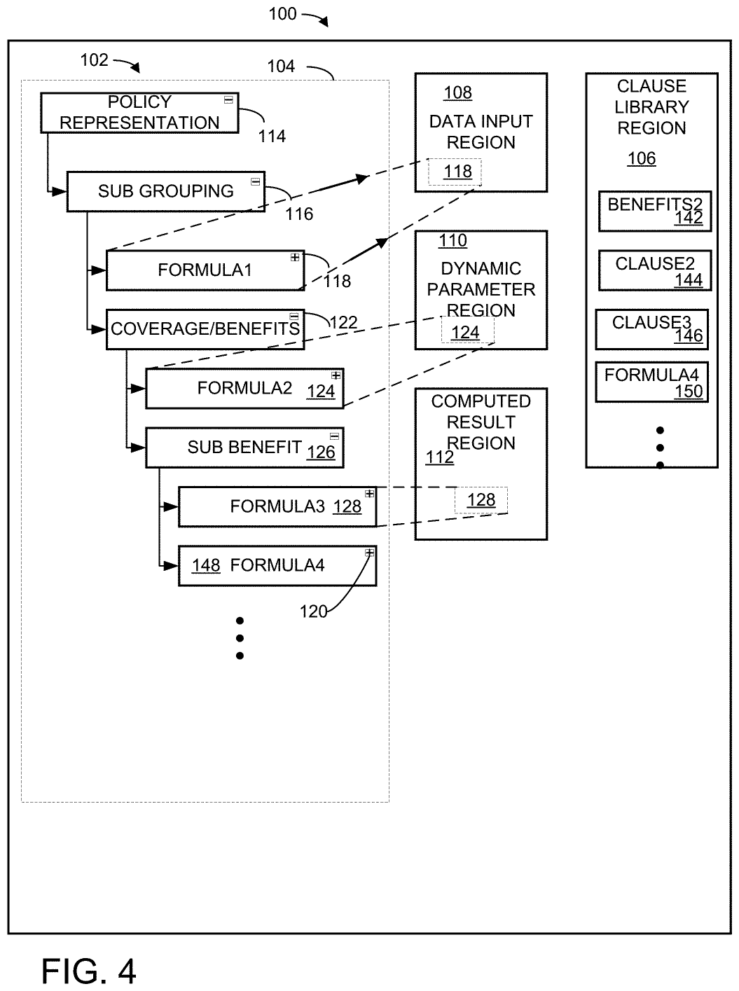

In one embodiment, according to FIG. 4, interactive elements 118, 124, and 128 may be selected by a user (e.g., either by a pointer to the elements 118, 124, and 128) and such selection may enable data input in regions 110, 124, and 128. In another embodiment, the interactive elements 118, 124, and 128 may further be dragged to regions 108, 110, or 112 to interact with the user. For example, when the interactive elements 102 are dropped to the data input region 118, the user may enter additional data as part of the interactive elements. Similar, when interactive elements 102 are dropped to the region 110, the user may configure or review dynamic parameter(s) of the interactive elements 102 (e.g., interactive element 124). Further, the region 112 may also accept interactive elements 102 for further configurations of the elements 102 by the user.

Aspects of the invention enable gesture-interactive approaches to insurance product generations. Users no longer need to possess technical background or coding skills to code using existing approaches to meet the insurance product policy requirements. Furthermore, aspects of the invention enable the users or administrators to develop or review insurance product policies at a faster pace. In some embodiments, the system 100 in FIGS. 1-4 enable a service provider to provide the system 100 as a platform to various insurance providers who can rapidly develop and configure desirable policies that can easily customized based on their needs. Furthermore, embodiments of the invention attempt to alleviate slow product configuration and time-to-market (display insurance clauses) by their existing systems and shorten feedback loops where claims experience affects underwriting and pricing decisions.

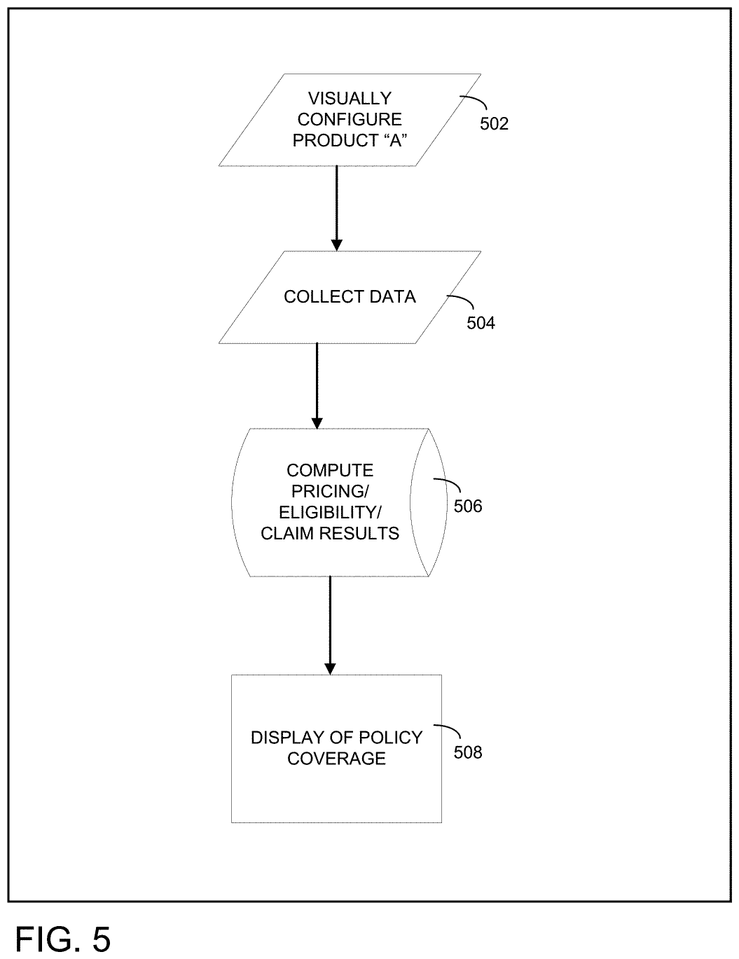

In one aspect, embodiments of the invention provide a computerized method for displaying insurance clauses relating to and facilitating configuration of an insurance product with digital, rules based, real-time computation of insurability, price and claims adjudication. For example, FIG. 5 provides an overall flow diagram illustrating such computerized method. In one embodiment, the method may enable visually configuring a product A at 502. In one embodiment, data is collected at 504 as part of the configuration. In one embodiment, aspects of the invention may provide application programming interfaces (APIs) to collect and/or interface with various systems. For example, aspects of the invention may interface with some legacy systems where policy clauses may be imported or exported and that the underlying data or metadata may be exchanged between them. Once accepted, embodiments of the invention may import the data to present to the user via the GUI system 100 and, upon interaction with the users, compute pricing or eligibility, configuration, or compute insurance claim results at 506. At 508, embodiments of the invention may display either policy coverage as a product or claim results.

Referring now to FIG. 6, another exemplary flow chart illustrates a computerized method according to some embodiments of the invention. At 602, providing an input region to a user via a graphical user interface to receive data input. In one example, the data input may include subject of an insurance contract and/or insurable events. In one embodiment, the input region may include a set of templates or a library of clauses of insurance contracts. At 604, providing a dynamic region that presents parameters for clauses selected by the user. In one embodiment, the dynamic region may process or configure parameters for the clauses selected by the user. In yet another embodiment, the dynamic region may be divided into sub parts. In another embodiment, the dynamic region may include various dynamic regions. At 606, the computerized method may further provide a policy/product (template of a policy) at a root position of a branched tree structure. In one embodiment, the structure may be a hierarchical structure. It is to be understood that one or more appropriate structure may be used without departing from aspects of the invention. In one embodiment, aspects of the invention may further provide regions representing groupings of insureds in relation to the policy in a region branched from the policy root position. In another embodiment, the computerized method may further provide benefit/cover regions in relation to the policy groupings in a position branched from the related policy groupings or policy region. In yet another embodiment, the computerized method may provide sub-benefit or sub-sub-benefit regions in a position branched from the related benefit/coverage region. In an alternative embodiment, aspects of the invention may provide limits to cover in regions in a position branched from the related benefit such that the limit corresponds to rules applying to said benefit and its nested sub-benefits.

Aspects of the invention may further provide formulas affecting pricing related to cover in regions in a position branched from the related benefit such that the pricing formulas region corresponds to experience-based pricing of said benefit and its nested sub-benefits. For example, embodiments of the invention may provide computed indications of the historical price of said benefits adjusted for variations in limits of coverage applied. Alternatively, embodiments of the invention may further provide logical formula regions in a position branching out to other regions that are either activated or deactivated as a result of applying the logic formula to the data pertaining to the insurance contract subject. At 608, the computerized method, in response to the input events and the structure and order of the regions, may provide a computed result of pricing, insurability and/or claims adjudication. At 610, the computerized method may further send the computation to a policy administration system.

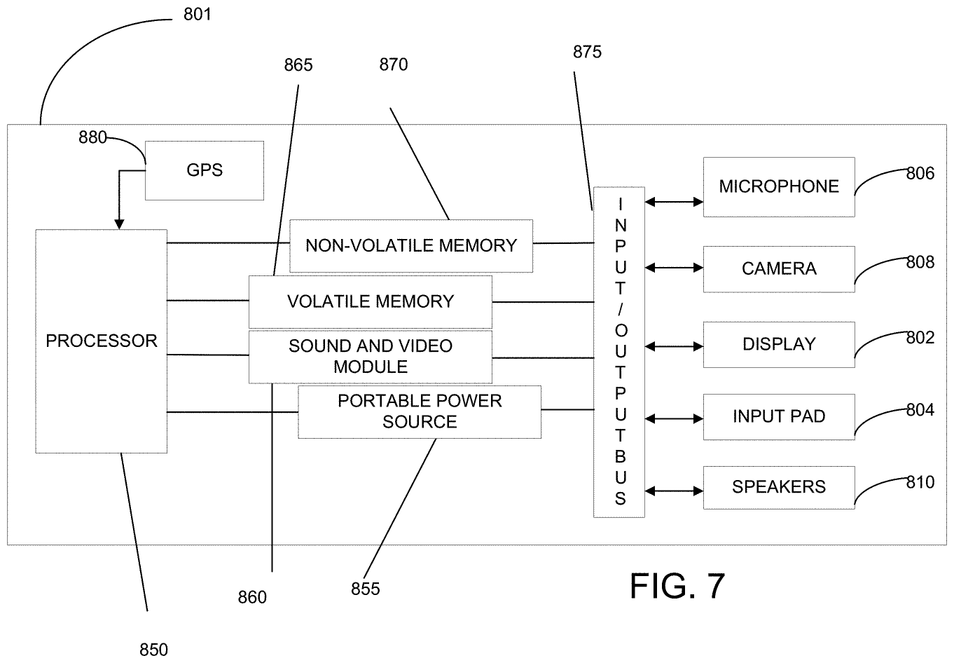

FIG. 7 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

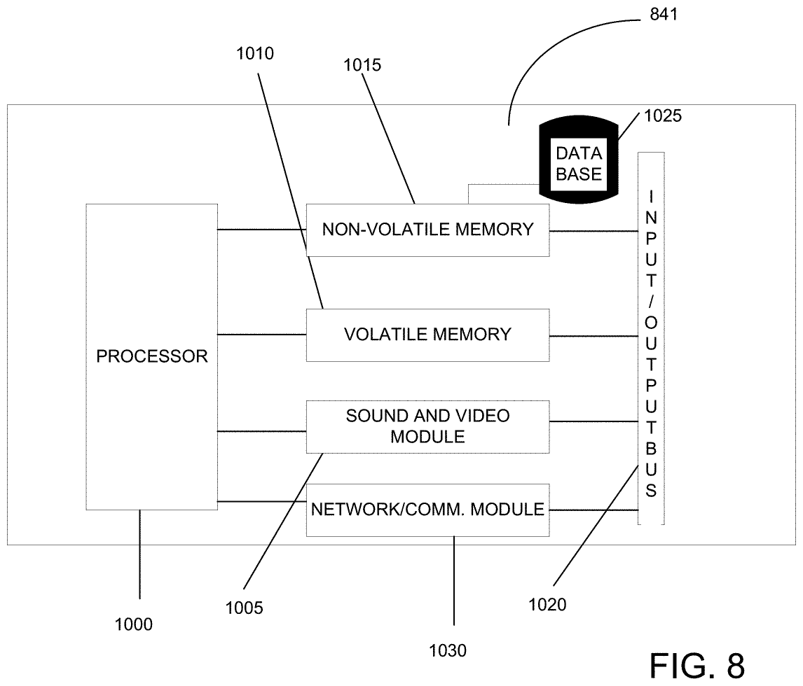

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network such as cellular service, through the Internet, through a private network, through Bluetooth, etc. FIG. 7 may be a simplified illustration of the physical elements that make up a portable computing device 801 and FIG. 8 may be a simplified illustration of the physical elements that make up a server type computing device 841.

FIG. 7 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 8. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The claimed system and method may address several technical problems and challenges, some of which are described. In one aspect, embodiments of the invention reduce a new insurance product configuration and testing time and IT development dramatically while allowing insurance professionals to intuitively configure digitized insurance products without computer programming. Aspects of the invention provide tools that enable insurance providers build more competitive insurance products with intuitive feedback from claims experience with short conception-to-market turnaround time. Furthermore, aspects of the invention further provide instant processing of claims while reducing fraud, waste and abuse.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

In one embodiment, the remote computing device 841 and the portable computing device 801 may execute the exemplary method shown in FIG. 4.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

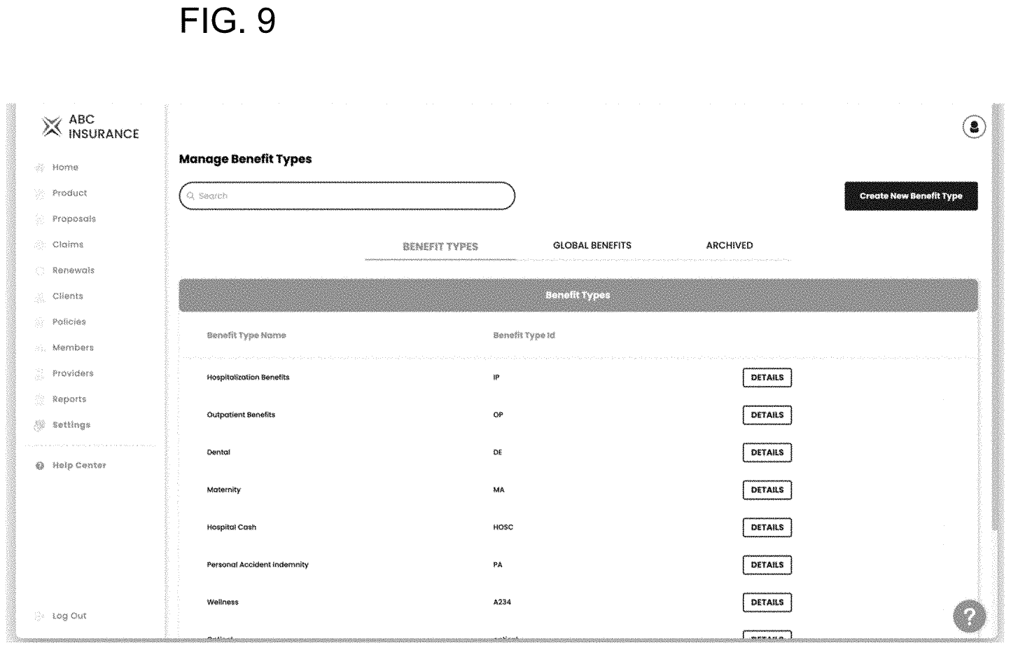

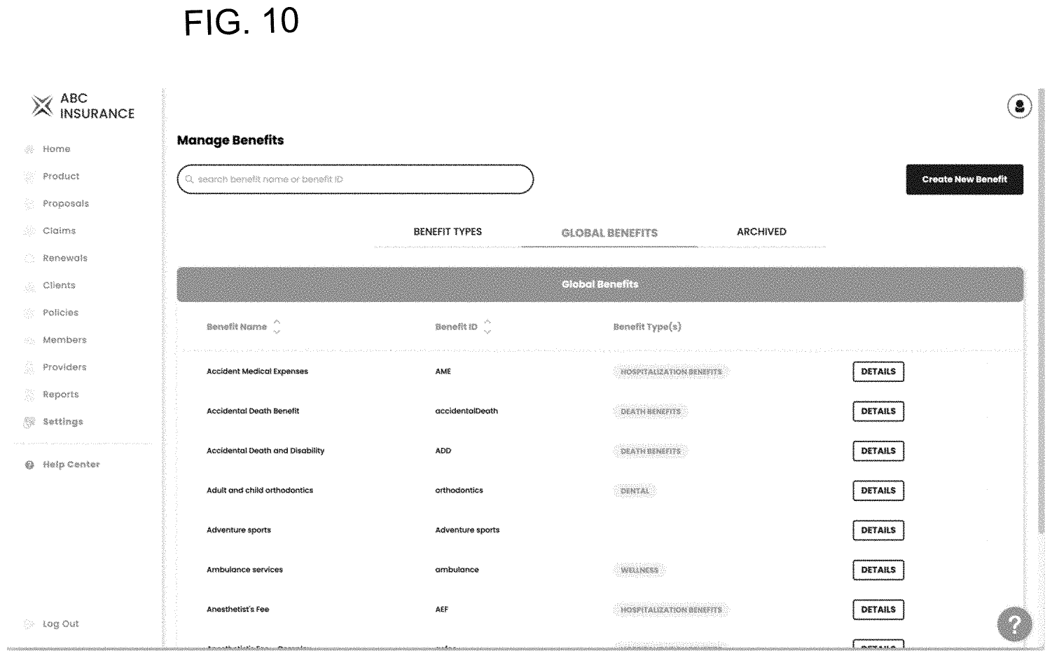

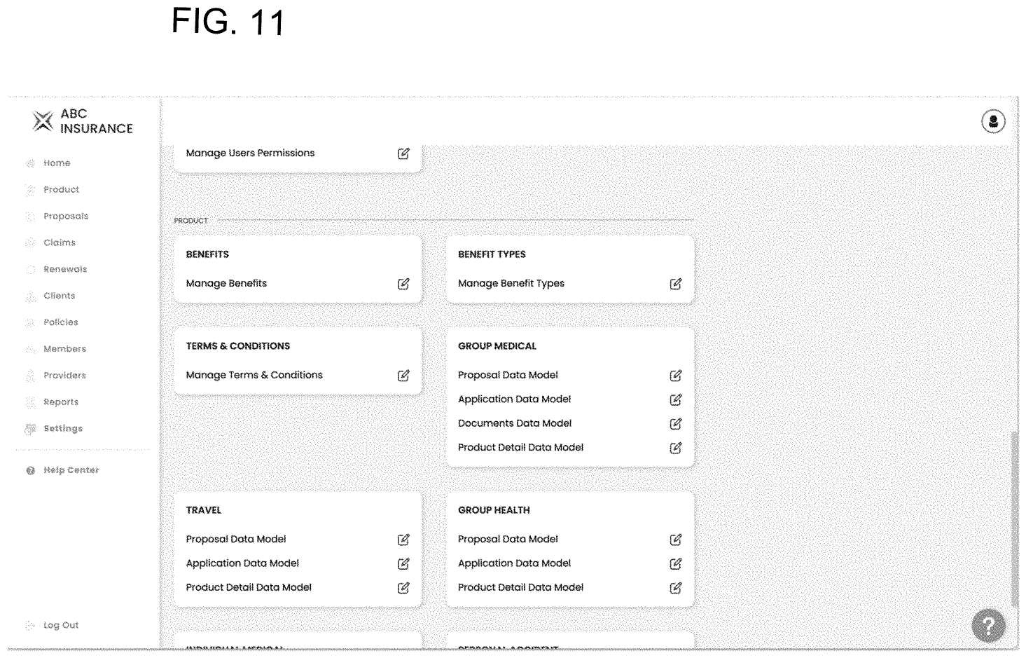

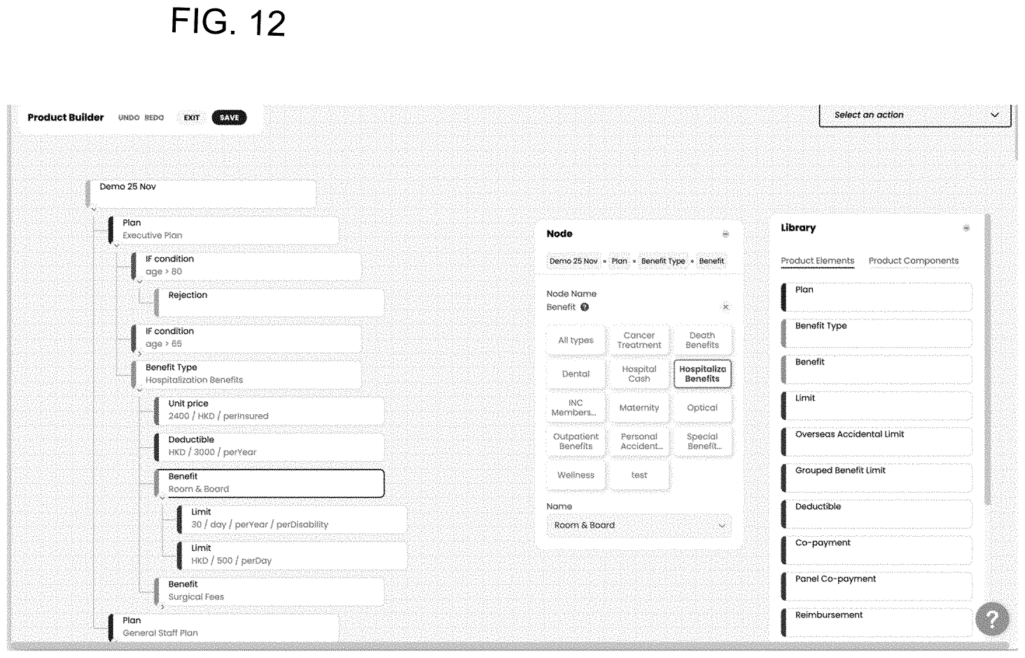

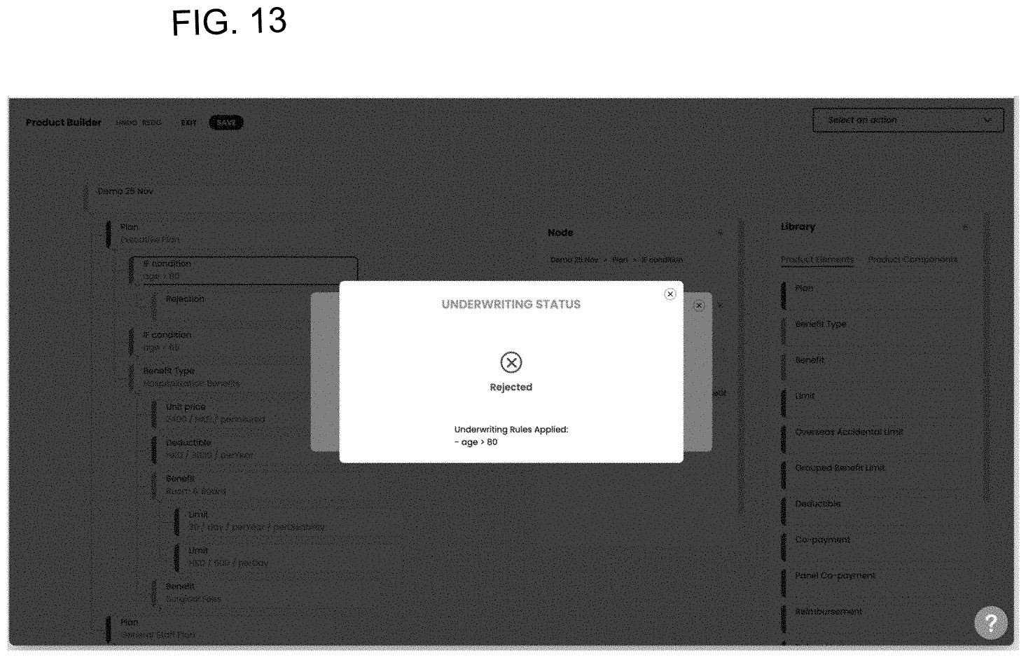

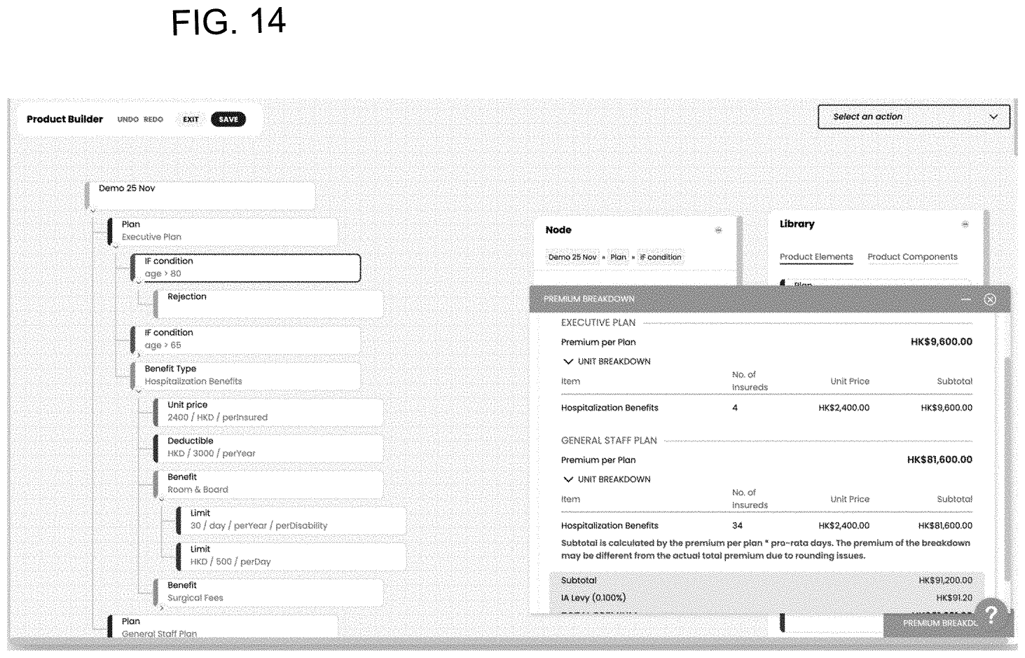

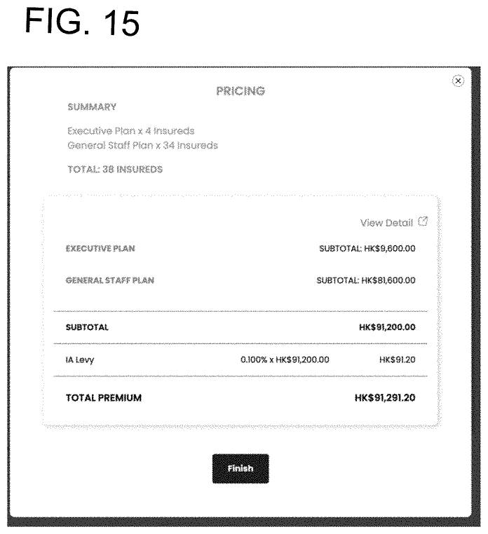

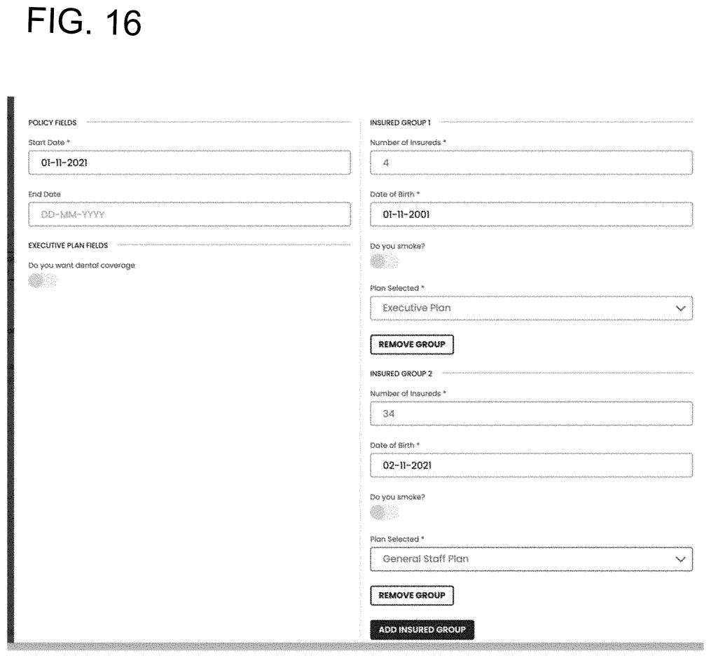

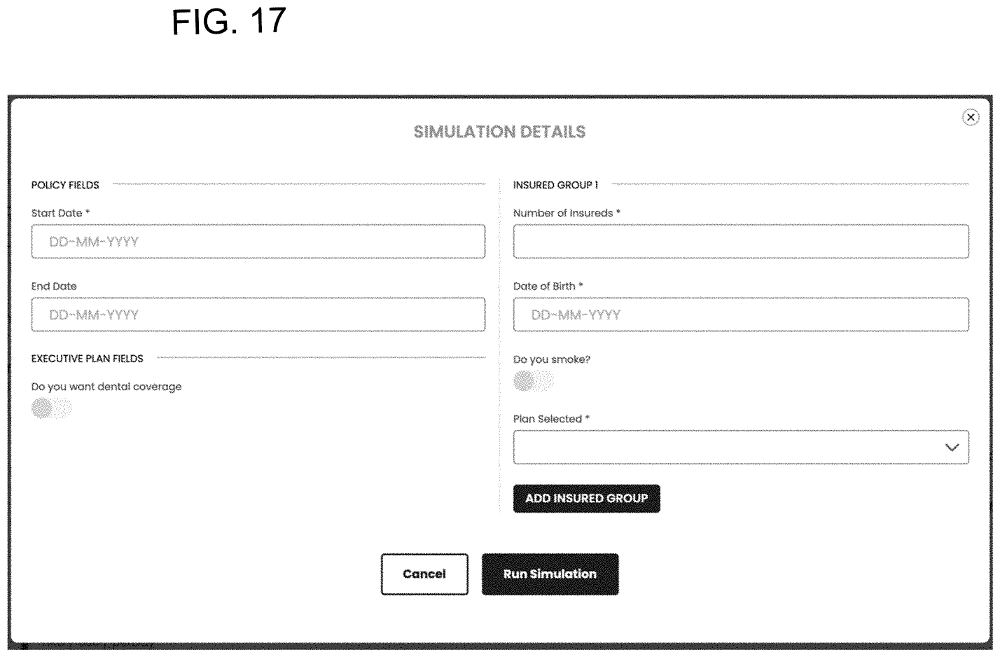

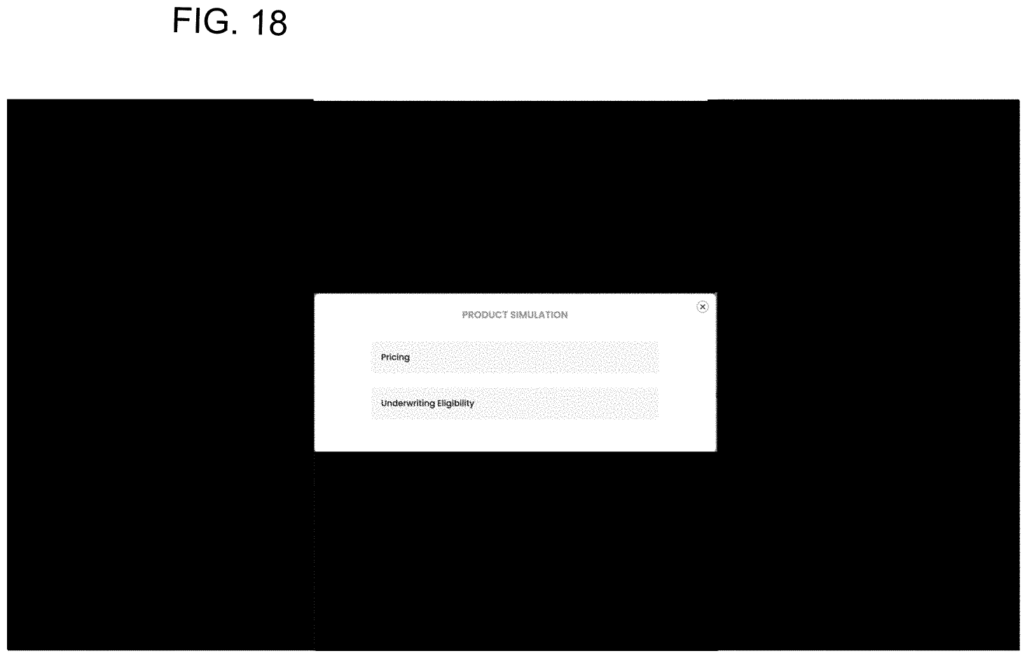

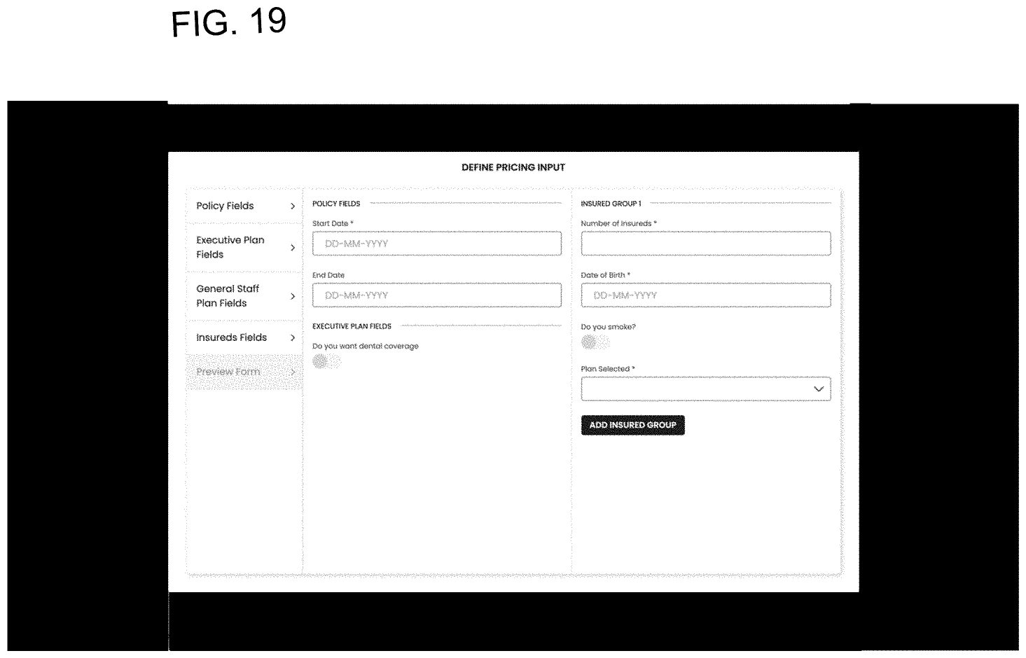

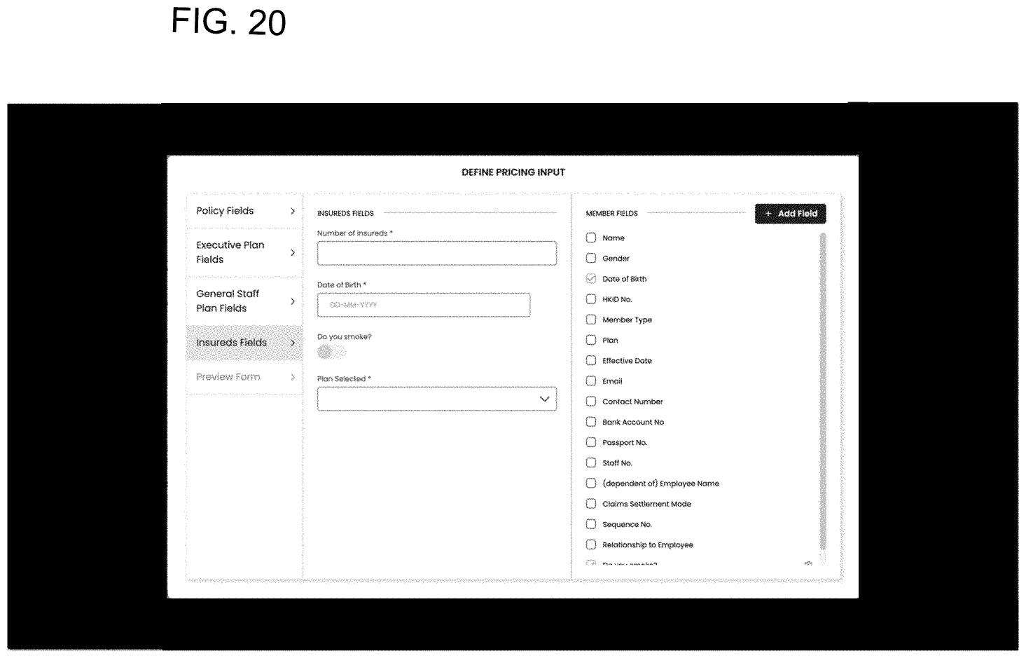

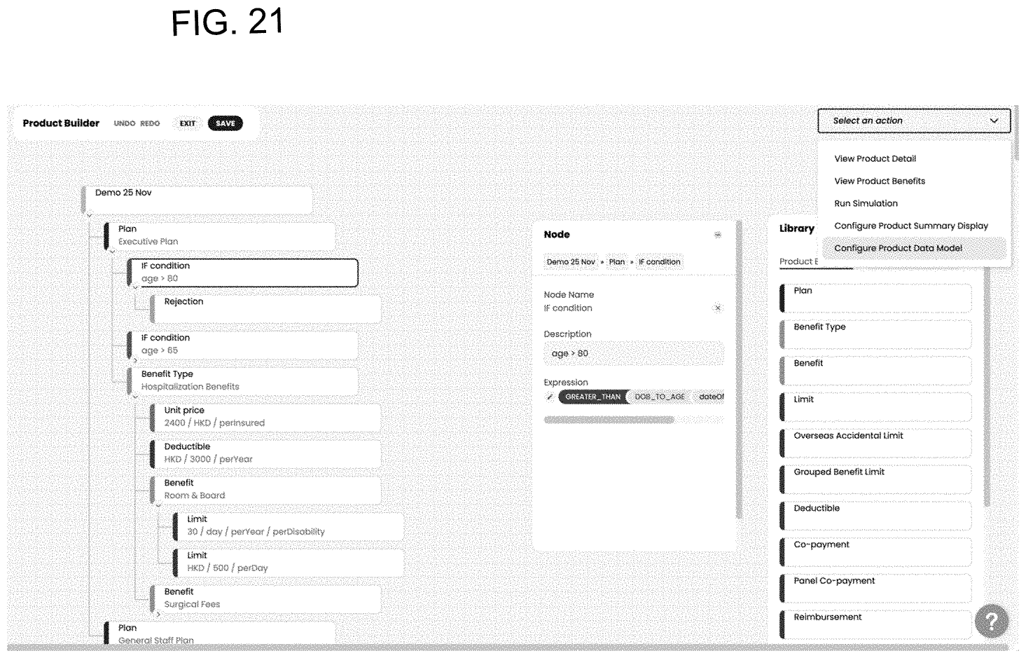

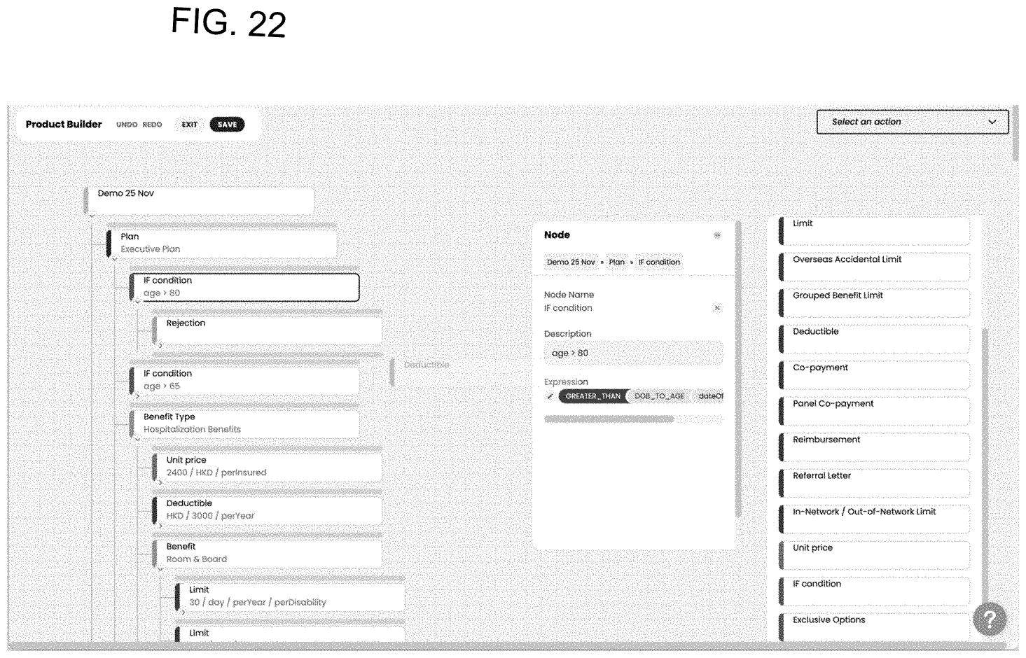

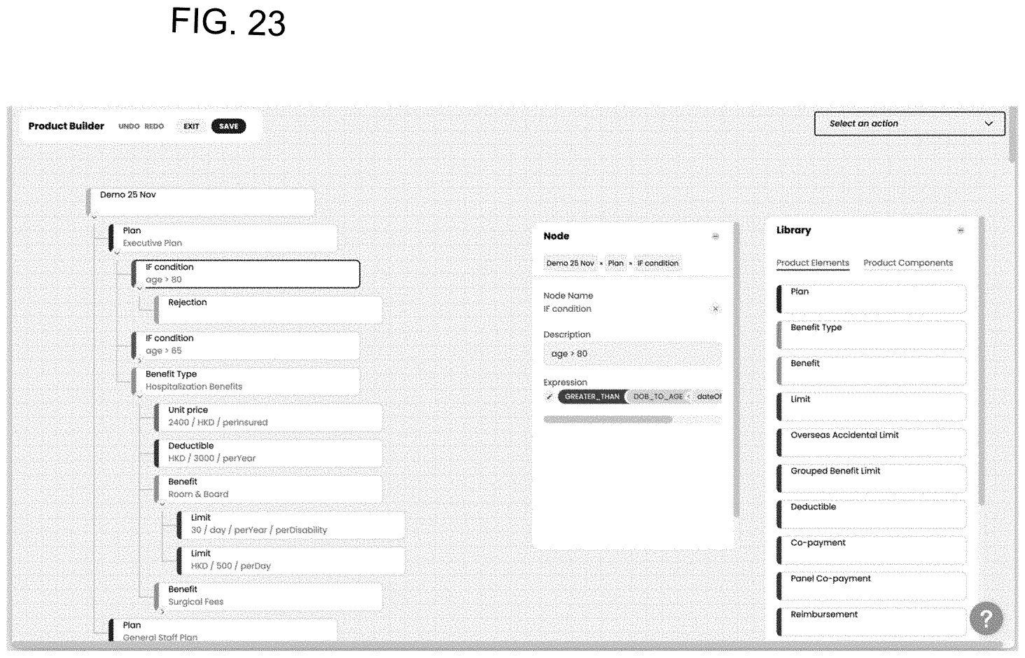

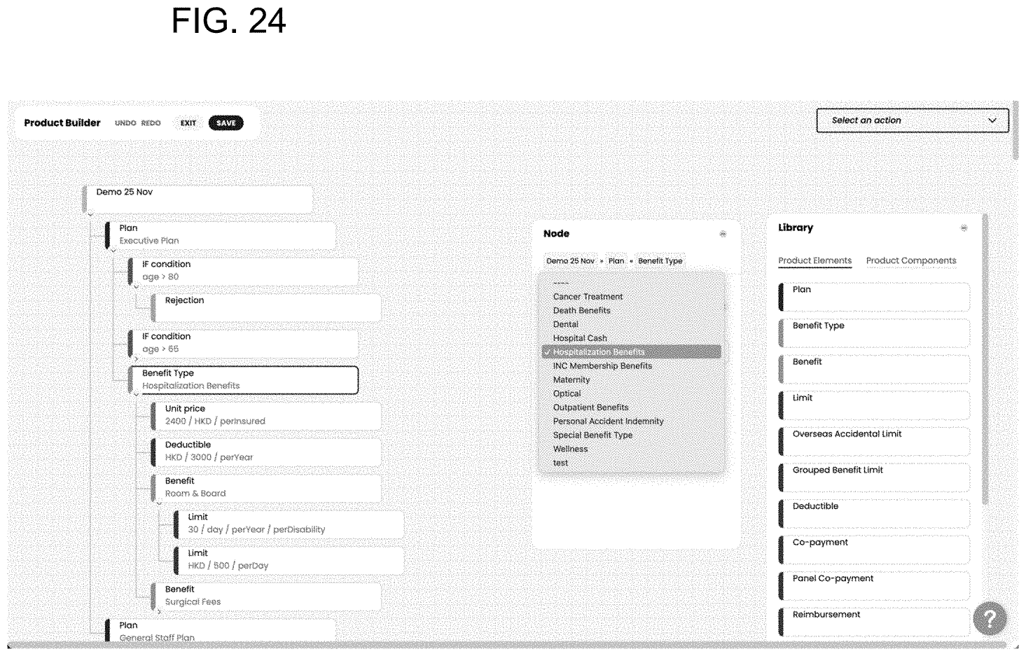

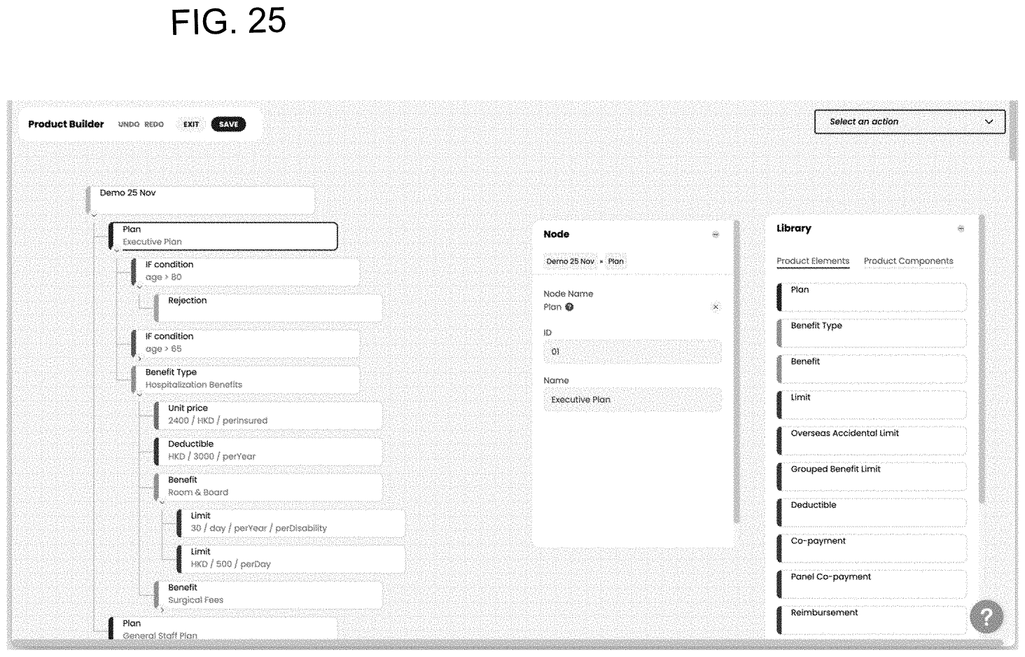

FIGS. 9-25 illustrate additional GUIs, screenshots and warning views according to some aspects of the invention.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving user graphical interface (GUI) associated with editing, composing, validating, or submitting API requests as described above. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A computer-implemented system for a dynamic insurance policy product composition comprising:
a processor configured to execute computer-executable instructions for defining one or more interactive nodes to be displayed on a graphical user interface (GUI) on a display, wherein each of the one or more interactive nodes includes data for composing at least one portion of an insurance policy product;
wherein the processor is configured to execute computer-executable instructions for defining one or more regions on the GUI, each of the one or more regions is defined by boundaries separating the one or more regions, wherein each of the one or more regions provides one or more actions to process data stored in the one or more interactive nodes;
wherein the GUI, being responsive to interactions with a user, monitors movements of the one or more interactive nodes across the one or more regions as a function of the interactions;
in response to the monitored movements, wherein the processor is configured to expose the data of the one or more interactive nodes to a particular region;
wherein the processor is configured to execute the one or more actions in the particular region on the data of the one or more interactive nodes; and
wherein the processor is configured to output the at least one portion of the insurance policy product as a function of the executed one or more actions.

2. The computer-implemented system of claim 1, wherein the interactions include a drag-and-drop gesture.

3. The computer-implemented system of claim 1, wherein the processor is configured to receive additional interactions from the user while executing the one or more actions in the particular region on the data of the one or more interactive nodes.

4. The computer-implemented system of claim 1, wherein the processor is further configured to execute computer-executable instructions to compute an insurance eligibility or an insurance policy pricing as a function of the at least one portion of the insurance policy product.

5. The computer-implemented system of claim 1, wherein the processor is further configured to execute computer-executable instructions to provide warnings in response to an organization of the at least one portion.

6. A computer-implemented graphical user interface (GUI) system for a dynamic insurance policy product composition comprising:
a processing component configured to execute computer-executable instructions for defining one or more regions on a GUI to be display on a display, wherein the one or more regions comprise one or more interactive elements to be displayed on the GUI, wherein each of the one or more interactive elements includes data for composing at least one portion of an insurance policy product;
wherein each of the one or more regions is defined by boundaries separating each of the one or more regions, wherein each of the one or more regions defines one or more actions to process data stored in the one or more interactive elements;
wherein the GUI, being responsive to interactions from a user, monitors movements of the one or more elements across the one or more regions as a function of the interactions;
in response to the monitored movements, wherein the processing component is configured to expose the data of the one or more interactive elements to a particular region;
wherein the processing component is configured to execute the one or more actions in the particular region on the data of the one or more interactive elements; and
wherein the processing component is configured to output the at least one portion of the insurance policy product as a function of the executed one or more actions.

7. The computer-implemented system of claim 6, wherein the interactions include a drag-and-drop gesture.

8. The computer-implemented system of claim 6, wherein the processing component is configured to receive additional interactions from the user while executing the one or more actions in the particular region on the data of the one or more interactive elements.

9. The computer-implemented system of claim 6, wherein the processing component is further configured to execute computer-executable instructions to compute an insurance eligibility or an insurance policy pricing as a function of the at least one portion of the insurance policy product.

10. A computer-implemented graphical user interface (GUI) system for a dynamic insurance policy document composition and adjudication comprising:
a processing component configured to execute computer-executable instructions for defining one or more regions on a GUI to be display on a display, wherein the one or more regions comprise one or more interactive elements to be displayed on the GUI, wherein each of the one or more interactive elements includes data for composing at least one portion of an insurance policy document;
wherein each of the one or more regions is defined by boundaries separating each of the one or more regions, wherein each of the one or more regions defines one or more actions to process data stored in the one or more interactive elements;
wherein the GUI, being responsive to interactions from a user, monitors movements of the one or more elements across the one or more regions as a function of the interactions;
in response to the monitored movements, wherein the processing component is configured to expose the data of the one or more interactive elements to a particular region;
wherein the processing component is configured to execute the one or more actions in the particular region on the data of the one or more interactive elements; and
wherein the processing component is configured to output the at least one portion of the insurance policy document as a function of the executed one or more actions.

11. The computer-implemented GUI system of claim 10, wherein the insurance policy document comprises an insurance policy product.

12. The computer-implemented GUI system of claim 10, wherein the insurance policy document comprises an insurance claim.

13. The computer-implemented GUI system of claim 12, wherein the one or more regions comprise an insurance claim interactive region, and a computed results region.

14. The computer-implemented GUI system of claim 13, wherein the processing component is configured to execute computer-executable instructions to receive one of the interactions with an insurance claim interactive node in the insurance claim interactive region from the user for adjudication against the insurance claim.

15. The computer-implemented GUI system of claim 14, wherein the processing component is configured to execute computer-executable instructions to process the insurance claim interactive node in real-time in response to the insurance claim interactive node being associated with the computed results region as a function of the interactions.

16. The computer-implemented GUI system of claim 10, wherein the interactions include a drag-and-drop gesture.

17. The computer-implemented GUI system of claim 10, wherein the processing component is configured to receive additional interactions from the user while executing the one or more actions in the particular region on the data of the one or more interactive elements.

18. The computer-implemented GUI system of claim 10, wherein the processing component is further configured to execute computer-executable instructions to compute an insurance eligibility or an insurance policy pricing as a function of the at least one portion of the insurance policy document.
